(19) United States
(12) Patent Application Publication
(10) Pub. No.: US 2010/0281511 A1
(43) Pub. Date: Nov. 4, 2010

(54) Multimedia System and Associated Control Method

(75) Inventor: Hung-Chi Huang, Hsinchu Hsien (TW)

Correspondence Address: WPAT, PC;INTELLECTUAL PROPERTY ATTORNEYS, 7225 BEVERLY ST., ANNANDALE, VA, 22003, US

(73) Assignee: MStar Semiconductor, Inc., Hsinchu Hsien (TW)

(21) Appl. No.: 12/749,741

(22) Filed: Mar. 30, 2010

(30) Foreign Application Priority Data
Apr. 30, 2009 (TW) 98111275

(51) Int. Cl. H04N 7/173; H04N 5/44

(52) U.S. Cl. 725/127; 348/734; 348/E05.096; 725/133

(57) ABSTRACT

A multimedia system and associated control method is provided. The multimedia system includes a remote control, a display device and a multimedia signal generator. A control method of the multimedia system includes steps of transmitting a remote control signal to the display device by the remote control, transmitting a local control signal associated with the remote control signal to the multimedia signal generator, generating an operation command by the multimedia signal generator in response to the local control signal, and executing the operation command by the multimedia signal generator.

### CROSS REFERENCE TO RELATED PATENT APPLICATION

This patent application is based on Taiwan, R.O.C. patent application No. 98111275 filed on Apr. 3, 2009.

### FIELD OF THE INVENTION

The present invention relates to a multimedia system and a control method thereof, and more particularly, to a multimedia system of a multimedia signal generator controlled by pressing a remote control and method thereof.

### BACKGROUND OF THE INVENTION

A new generation television (TV) such as a liquid crystal display (LCD) TV or a plasma display panel (PDP) TV can be connected with a personal computer (PC) via a transmission line, e.g., an analog signal transmission line such as a video graphic array (VGA) transmission line, or a digital signal transmission line such as a DVI transmission line. TV can be a display device for the PC. A user can play audio-visual data of the PC on the TV via a transmission media. For example, video files of music or films from the PC can be played on the TV.

Refer to FIG. 1 showing a block diagram of an LCD TV connected to a PC. When an LCD TV 12 is connected to a PC 14 via a transmission line 18 such as an analog transmission line, the LCD TV 12 can serve as a display device for the PC 14. For example, the LCD TV 12 displays images of multimedia files and outputting corresponding audios of the PC 14. When the user wishes to control the LCD TV 12, a remote control 10 dedicated to the TV is needed to adjust the volume or image quality. However, when the user wishes to control the PC 14 to fast forward or to pause the film currently playing, an input device 16, such as a wired or wireless mouse or a keyboard, for the PC 14 is needed. That is, when the user wishes to control the LCD TV 12 or the PC 14, the remote control 10 and the input device 16 are respectively used for the adjustments, which is rather inconvenient for the user.

Therefore, a main object of the present invention is to provide a proper device and method to solve the foregoing problem.

### SUMMARY OF THE INVENTION

The main object of the present invention is to provide a multimedia system and control method thereof. A user can control a multimedia signal generator by pressing buttons of a remote control, thereby increasing usage convenience.

A multimedia control method according to an embodiment of the present invention is disclosed. The method is applied to a display device and a multimedia signal generator. The method comprises steps of transmitting a remote control signal by a remote control to the display device, transmitting a local control signal associated with the remote control signal to the multimedia signal generator, generating an operation command by the multimedia signal generator in response to the local control signal transmitted by the display device, and executing the operation command by the multimedia signal generator.

A multimedia system according to an embodiment of the present invention is further disclosed. The system comprises a multimedia signal generator capable of executing a multimedia program, a remote control for transmitting a remote control signal, and a display device coupled to the remote control and the multimedia signal generator. The display device receives the control signal transmitted by the remote control, and transmits a local control signal associated with the remote control signal to the multimedia signal generator via wired or wireless transmission. Accordingly, an operation command is generated to control the multimedia program by the multimedia signal generator in response to the local control signal.

With the multimedia system and control method thereof according to the present invention, a remote control signal generated by pressing buttons of a remote control associates with an operation command of a multimedia signal generator, thereby facilitating the user controlling the multimedia signal generator.

Following description and figures are disclosed to have a better understanding of the advantages of the present invention.

### BRIEF DESCRIPTION OF THE DRAWINGS

FIG. 1 is a block diagram of a conventional LCD TV connected to a PC.

FIG. 2 is a block diagram of a multimedia system in accordance with a preferred embodiment of the present invention.

FIG. 3 (a) is a flow chart of a method for transmitting a control signal from a remote control to an LCD TV in accordance with a preferred embodiment of the present invention.

FIG. 3 (b) is a flow chart of a method of a PC system receiving a control signal transmitted by an LCD TV in accordance with a preferred embodiment of the present invention.

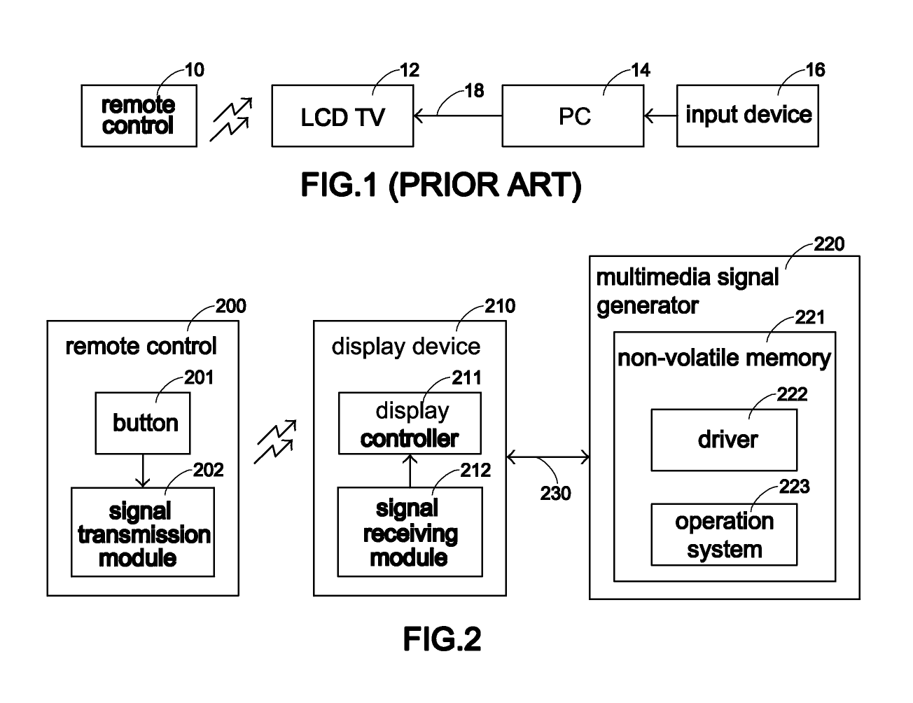

### DETAILED DESCRIPTION OF THE PREFERRED EMBODIMENT

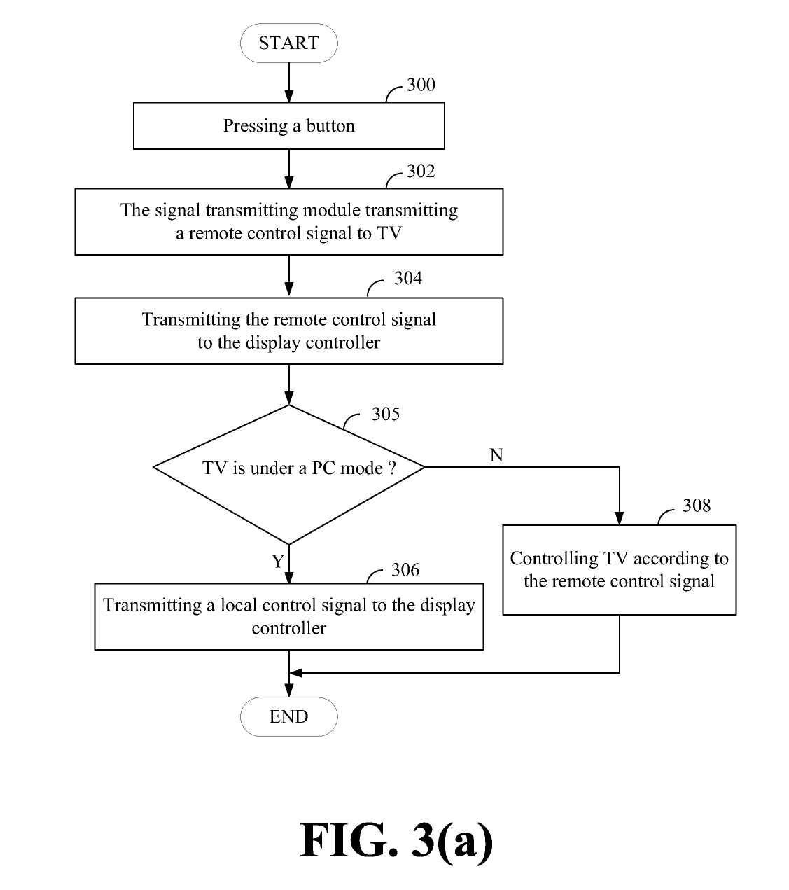

Referring to FIG. 2 showing a block diagram of a multimedia system in accordance with a preferred embodiment of the present invention. The multimedia system according to the present invention comprises a multimedia signal generator 220, a remote control 200, and a display device 210. The remote control 200 comprises at least one button 201 and a signal transmission module 202. The display device 210 comprises a signal receiving module 212 and a display controller 211 signally connected to the signal receiving module 212. The display device 210 couples to the multimedia signal generator 220 via a signal transmission line 230. The multimedia signal generator 220, e.g., a computer system, comprises a non-volatile memory 221 stored with a driver 222 and an operation system 223. For example, the non-volatile memory 221 can be a hard disk or a flash memory. In addition, the display device 210 can be an LCD TV, a PDP TV, or a cathode ray tube (CRT) TV, and the signal transmission line 230 is an analog signal transmission line, such as a VGA transmission line, or a digital signal transmission line, such as a DVI transmission line or a high definition multimedia interface (HDMI) transmission line. In the following description, for example, the display device 210 is an LCD TV and the multimedia signal generator 220 is a computer system.

Generally speaking, an LCD TV supports various signal source input modes, including an HDMI mode, a separated video (S-video) mode, a component video mode, a composite video mode, a digital TV mode, an analog TV mode, and a PC mode. When the LCD TV is in the foregoing modes except the PC mode, a display controller 211 of the LCD TV correspondingly controls a general operation of the LCD TV according to a remote control signal generated from pressing buttons by a user. For example, when the user presses a channel switching button, the display controller 211 performs a control action of switching the channel. The display controller 211 correspondingly performs the control action of adjusting the volume when the user presses a volume adjusting button.

When the LCD TV is in the PC mode, the LCD TV serves as a display device of a PC system. That is, when the LCD TV is in the PC mode, even if the user presses a certain button, such as a channel switching button or a channel up and down button, the conventional display controller does not perform corresponding predetermined actions. Therefore, the following methods are developed according to the present invention to overcome the disadvantages of the prior art.

In this embodiment, for example, the display device 210 is an LCD TV, and the multimedia signal generator 220 is a PC system. The driver 222 executed on the PC system processes a signal transmitted from the LCD TV to the PC system via the signal transmission line 230. The display controller 211 of the LCD TV determines whether the LCD TV is in the PC mode. Under the PC mode, when the user sends a corresponding remote control signal to the LCD TV by pressing a certain button 201 of the remote control 200, the display controller 211 of the LCD TV, in addition to perform the action specified by the control signal, further transmits a local control signal associated with the remote control signal to the PC system via the signal transmission line 230. The local control signal is processed by the driver 222 installed in the PC system and further converted to an operating command for controlling the PC system to operate accordingly. After that, the operating command is executed by the operation system 223 of the PC system. Other than the signal transmission line 230 used by the LCD TV to transmit the local control signal to the PC system via the signal transmission line 230, an inter-integrated circuit (I²C) bus of an analog video signal transmission, a transport stream protocol of a universal serial bus (USB), or a wireless transmission media such as Bluetooth may also be applied for transmitting the local control signal.

Accordingly, when the PC system displays images on the LCD TV under the PC mode, it is rather convenient to execute a multimedia program to play a multimedia file. For example, when the user presses a button number 1 of the remote control 200, the LCD TV under the PC mode remains unresponsive to a remote control signal generated by pressing the button number 1. Instead, the control signal, first transmitted to the PC system, is processed and converted by the driver 222 into a multimedia command, which controls a play function button of a multimedia player program (e.g., Mediaplayer program) of the PC system. In other words, by pressing the button number 1 of the remote control 200, the user is allowed to control/play the multimedia program. Similarly, via the transmission of the LCD TV and the conversion of the driver 222 of the PC system, the channel switching button, for an example, can be programmed to correspondingly control a fast forward function button or a rewind function button of the multimedia player program. Alternatively, buttons with numbers 2, 4, 6, 8 of the remote control 200 are pressed by the user to correspondingly control a mouse cursor of the PC system to move up, left, right and down, and a button with number 5 is pressed to correspondingly control the mouse as clicking action. The remote control signal generated by pressing the foregoing buttons (e.g., the button numbers or the channel switching buttons) associates with the operation commands of, e.g., play, fast forward, rewind, and moving and clicking of the mouse of the PC system. The conversion between the control signal and the operation commands by the driver 222 can be defined via a user interface program executed on the PC system. According to the disclosure of the foregoing embodiments, the LCD TV under the PC mode provides much more convenience by the remote control 200. For example, a basic multimedia program operation or browsing the Internet can be performed by the remote control 200. Input devices including a conventional remote control, the mouse, and a keyboard need not be alternately used in multimedia operations. Preferably, the LCD TV may be sold as a peripheral device of the PC system, and a compact disk (CD) recorded with the driver 222 is provided to the user as a service pack along with the LCD TV.

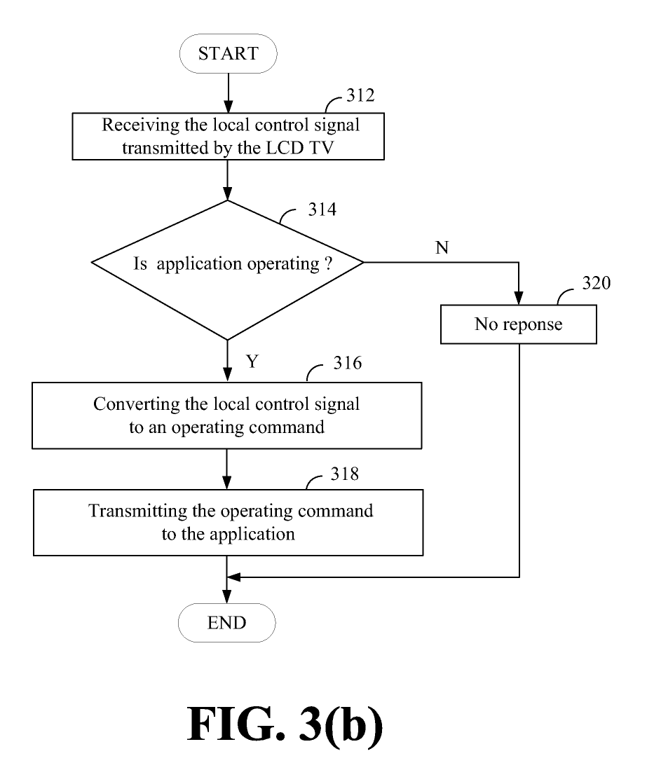

FIGS. 3(a) and 3(b) show flow charts of a control method of operating a multimedia system in accordance with an embodiment of the present invention. Refer to FIG. 3(a) showing the method for transmitting a remote control signal from a remote control to an LCD TV. In Step 300, a user presses a button 201. In Step 302, when the user presses the button 201, the signal transmitting module 202 transmits a remote control signal corresponding to the button 201 to the LCD TV 210. In Step S304, the signal receiving module 212 of the LCD TV receives the remote control signal and forwards it to the display controller 211. In Step 305, the display controller 211 determines whether the LCD TV is under a PC mode. When the LCD TV is not under the PC mode, Step 308 is performed. In Step 308, the display controller 211 controls the LCD TV according to the remote control signal. Otherwise, Step 306 is performed. In Step 306, the display controller 211 transmits a local control signal associated with the control signal to the PC system, for example, through an inter-integrated circuit (I²C) bus of an analog video signal transmission, a transport stream protocol of a universal serial bus (USB) or a wireless transmission media such as Bluetooth.

Refer to FIG. 3(b) showing a flow chart of a method of a PC system receiving a local control signal transmitted by an LCD TV. In Step 312, the PC system receives the local control signal transmitted by the LCD TV via the signal transmission line 230. After that, in Step 314, the operation system 223 checks whether an associated application is operating. In Step 320, when the answer of Step 314 is no, the computer system will not responded to the received local control signal. In Step 316, when the answer of Step 314 is yes, the driver 222 converts the local control signal to an operating command executable on the operation system 223 of the PC system. In Step 318, the driver 222 transmits the operating command to the application of the operation system, and the operating command is executed by the application.

In conclusion, the multimedia system and control method according to the present invention facilitates a user controlling a PC system via a remote control signal by pressing buttons of a remote control.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A multimedia control method, applied to a television (TV) and a multimedia signal generator, the multimedia control method comprising:
receiving a remote control signal by the TV;
generating a local control signal by the TV, wherein the local control signal is associated with the remote control signal;
transmitting the local control signal to the multimedia signal generator;
generating an operating command by the multimedia signal generator in response to the local control signal; and
executing the operating command by the multimedia signal generator.

2. The multimedia control method as claimed in claim 1, wherein the remote control signal is a wireless signal, and the wireless signal transmitted by a user pressing a button of a remote control.

3. The multimedia control method as claimed in claim 1, wherein the TV selectively operates according to the remote control signal under a first mode or a second mode, and the TV transmits the local control signal to the multimedia signal generator when the TV is under a second mode.

4. The multimedia control method as claimed in claim 3, wherein the first mode is a high definition multimedia interface (HDMI) mode, a separated video (S-video) mode, a component video mode, a composite video mode, a digital TV mode, or an analog TV mode.

5. The multimedia control method as claimed in claim 3, wherein the second mode is a personal computer (PC) mode.

6. The multimedia control method as claimed in claim 1, wherein the multimedia signal generator is a PC system comprising a driver, a operating system, and an application, the driver converts the local control signal transmitted by the TV to an operating command executable on the operation system and transmits the operating command to the application for execution.

7. The multimedia control method as claimed in claim 6, further comprising:
providing a user interface for defining the operating command corresponding to the local control signal.

8. The multimedia control method as claimed in claim 1, wherein the operating command is a multimedia operating command.

9. A multimedia system, comprising:
a multimedia signal generator for executing a multimedia program;
a remote control for transmitting a remote control signal; and
a TV controlled by the remote control and coupled to the multimedia signal generator;
wherein the TV receives the remote control signal transmitted by the remote control and selectively transmits a local control signal associated with the remote control signal to the multimedia signal generator, so that the multimedia signal generator generates an operating command to control the multimedia program in response to the local control signal.

10. The multimedia system as claimed in claim 9, wherein the TV comprises a display controller for transmitting the local control signal to the multimedia signal generator.

11. The multimedia system as claimed in claim 10, wherein the multimedia signal generator is a personal computer (PC) system comprising a driver, an operation system, and the multimedia program, and the driver generates the operating command for the multimedia program in response to the local control signal transmitted by the TV.

12. The multimedia system as claimed in claim 10, wherein the remote control comprises a first button for generating the remote control signal when a user presses the first button.

13. The multimedia system as claimed in claim 12, further comprising:
a signal transmission module located in the remote control; and
a signal receiving module located in the TV;
wherein the signal transmitting module transmits the remote control signal to the signal receiving module when the user presses the first button, and the display controller selectively transmits the local control signal to the multimedia signal generator via the signal receiving module.

14. The multimedia system as claimed in claim 10, wherein the display controller controls the TV according to the remote control signal in response to a first mode of the TV, and transmits the local control signal to the multimedia signal generator in response to a second mode of the TV.

15. The multimedia system as claimed in claim 14, wherein the first mode is an HDMI mode, a separated video (S-video) mode, a component video mode, a composite video mode, a digital TV mode, or an analog TV mode.

16. The multimedia system as claimed in claim 14, wherein the second mode is a PC mode.

17. The multimedia system as claimed in claim 9, wherein the TV signally connected to the multimedia signal generator via a signal transmission line, and the TV transmits the local control signal to the multimedia signal generator via the signal transmission line.

18. The multimedia system as claimed in claim 17, wherein the signal transmission line is a video graphic array (VGA) transmission line, a universal serial bus (USB) transmission line, a digital visual interface (DVI) transmission line, or an HDMI transmission line.
